(19) United States
(12) Patent Application Publication
(10) Pub. No.: US 2009/0038535 A1
(43) Pub. Date: Feb. 12, 2009

(54) Instrument Pointer Assembly

(76) Inventors: Jorge Morales, Chihuahua (MX); Sergei Kalashnikov, West Bloomfield, MI (US)

Correspondence Address: VISTEON/BRINKS HOFER GILSON & LIONE, 524 South Main Street, Suite 200, Ann Arbor, MI, 48104, US

(21) Appl. No.: 11/834,769

(22) Filed: Aug. 7, 2007

(51) Int. Cl. G01D 11/28

(52) U.S. Cl. 116/288

(57) ABSTRACT

An instrument pointer assembly package for illuminating an instrument pointer is provided. The assembly package has an instrument pointer, a light pipe socket, a motor, and a plurality of light sources. The instrument pointer has a blade portion and a stem portion. The light pipe socket has a terminus portion located along a rotational axis, which is connected to the stem portion of the instrument pointer. The light pipe socket also has a base portion, which is located longitudinally farther along the rotational axis from the instrument pointer than the terminus portion. The base portion has a diameter that is larger than the diameter of the upper portion. A side tapers inward from the base portion toward the terminus portion.

### BACKGROUND

1. Field of the Invention

The present invention generally relates to gauges, and more particularly, to gauges having an illuminated instrument pointer.

2. Description of Related Art

Typical instrument pointers are connected directly to a stepper motor shaft, which rotates the instrument pointer about a rotational axis. A light-emitting diode (LED), or a plurality of LEDs, have been located in a variety of places to illuminate an instrument pointer. For example, an LED configured to supply light to the instrument pointer could be located in the rotating stem of the instrument pointer. This configuration typically uses just one LED and must provide an electrical connection to the LED located in the stem of the instrument pointer.

In another configuration, multiple LEDs have been located on a circuit board that is located just in front of the stepper motor. In this configuration, the LEDs typically surround the stepper motor shaft and shine straight up into the instrument pointer, which has a wide hub to collect the light. The wide hub is typically an integral part of the instrument pointer stem, and a large opening in the associated back plate and appliqué surface are necessary to allow the light to reach the hub. Sometimes an anti-halo ring is used with this configuration to avoid light leakage to the appliqué surface. Since the hub must be large enough to receive the light from the LEDs, the openings in the back plate and the appliqué surface, as well as the pointer hub, typically have had a diameter of about 14 mm. Furthermore, the anti-halo ring may cause the diameter of the assembly to be even larger. However, in automotive applications, smaller diameters can be desirable, because they consume less space on an instrument panel. Some vehicle manufacturers would prefer that the diameters of the pointer stem and the associated opening in the appliqué surface be significantly reduced, by as much as, if not more than, 25%. For example, some prefer that the diameter of the center of the instrument pointer does not exceed 10 mm.

In view of the above, it is apparent that there exists a need for an instrument pointer construction, configured for use with multiple LEDs, that allows for a significant reduction in the central diameter of the instrument pointer.

### SUMMARY

In satisfying the above need, as well as overcoming the enumerated drawbacks and other limitations of the related art, the present invention provides an illuminated instrument pointer assembly. The instrument pointer assembly is configured to enable a reduction in the diameter of the pointer stem or hub, preferably such that this diameter does not exceed 10 mm.

The assembly comprises an instrument pointer having a blade and a stem. The stem has a rotational axis extending therethrough, and the blade is configured to rotate with the stem about the rotational axis. The assembly also comprises a light pipe. The light pipe is a body of revolution that is symmetric about the rotational axis. The light pipe includes an upper or terminus portion, a base portion, an intermediate portion, and a light-collecting side. The terminus portion, defines an effective diameter, is located along the rotational axis and is connected to the stem portion of the instrument pointer. The base portion is also located along the rotational axis, but is at a position longitudinally farther away from the stem than the terminus portion. The base portion defines an effective diameter that is larger than that of the terminus portion. The intermediate portion, which exists in some but not all embodiments, has sides that taper inward from the base portion toward the terminus portion, such that the intermediate portion has a conical shape. A light-collecting face is provided on the base portion and is configured to collect light from a light source. The light pipe transmits at least a portion of this light to the instrument pointer.

In another aspect, an instrument pointer assembly package for illuminating an instrument pointer is provided. In addition to the above, the assembly package includes a motor, a plurality of light sources, and an appliqué. The motor has a shaft extending therefrom along the rotational axis and the stem is coupled to the shaft. The motor can therefore rotate the instrument pointer about the rotational axis. The plurality of light sources is positioned generally around the shaft.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a perspective view of an instrument pointer assembly embodying the principles of the present invention;

FIG. 2 is an exploded perspective view of the instrument pointer assembly of FIG. 1, with other associated components that may be provided with the instrument pointer assembly to provide an instrument pointer assembly package;

FIG. 3 is a cross-sectional view of the instrument pointer assembly package of FIG. 2, having light rays being directed through the instrument pointer assembly;

FIG. 4 is a cross-sectional view of another instrument pointer assembly package embodying the principles of the present invention;

### DETAILED DESCRIPTION

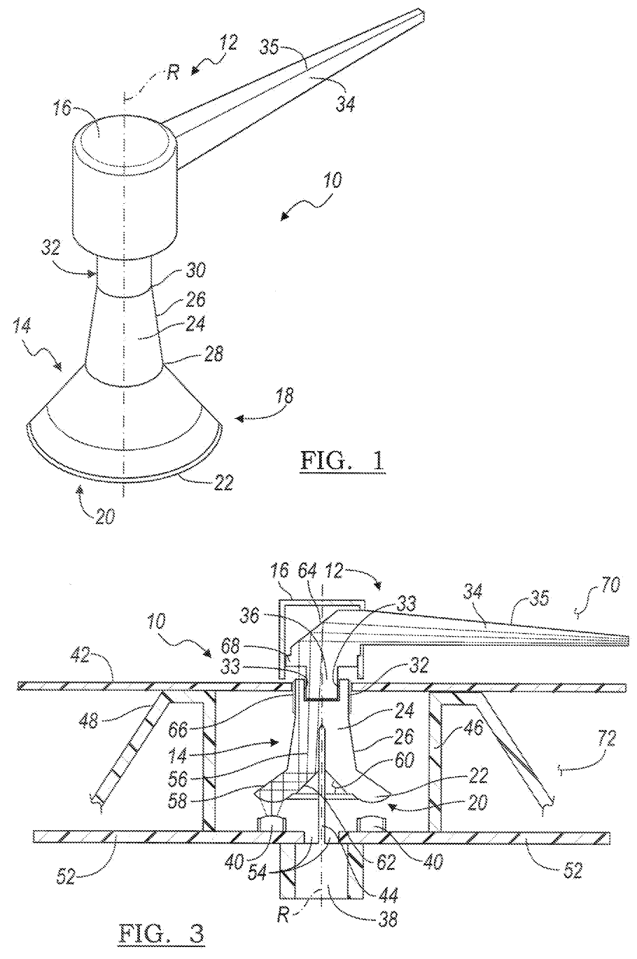

Referring now to FIG. 1, an instrument pointer assembly embodying the principles of the present invention is illustrated therein and designated at 10. The instrument pointer assembly 10 includes an instrument pointer 12 and a light pipe 14 and is configured to rotate about a rotational axis R.

The light pipe 14 is a body of revolution symmetric about and located along the rotational axis R, although the light pipe 14 could have other configurations without falling beyond the spirit and scope of the present invention. The light pipe 14 includes a base portion 18, an intermediate portion 24, and a terminus portion 32.

The base portion 18 is preferably conical. However, it should be understood that the base portion 18 may have other configurations without falling beyond the spirit and scope of the present invention, especially if provided with a light pipe 14 having a configuration that is not symmetrical about the axis of revolution R.

The base portion 18 has an end face that is a light-collecting face 20, in other words, a light receiving side. The light-collecting face 20 preferably includes a focusing lens 22, which may be a collimating lens, to direct light rays along desired paths through the light pipe 14. As is further described below, the light collecting face 20 is therefore configured to collect light from a light source and transmit at least a portion of the light therethrough, eventually to the instrument pointer 12.

The light pipe 14 also has an intermediate portion 24 extending from the base portion 18. The intermediate portion has a side 26 that (in the direction extending from the base portion 18 to the terminus portion 32) tapers inward toward the axis R, such that the diameter of the intermediate portion 24 is larger at an end section 28 that connects to the base portion 18 and smaller at the opposing end section 30 that connects to the terminus portion 32. In other words, the intermediate portion 24 has a conical shape. It should be understood that the side 26 could comprise multiple sides, particularly if the intermediate portion 24 has a different cross section, such as a triangular or rectangular cross section.

As indicated above, the intermediate portion 24 is connected to a terminus portion 32, which in turn is connected to the instrument pointer 12. The terminus portion 32 preferably has a circular cross section and is preferably symmetrical about the rotational axis R. As is apparent in the figures, the diameter of the terminus portion 32 is smaller than the diameter of the base portion 18. As constructed, the terminus portion 32 is located closer to the instrument pointer 12 than the base portion 18. One benefit of this configuration is that light is first collected in the base portion 18, through its larger diameter, and channeled upward into the terminus portion 32, such that the light is transmitted to the instrument pointer 12 through the narrow diameter. This not only concentrates the light, but also allows the terminus portion 32 to be considerably smaller in diameter without sacrificing light-collecting surface area of the light pipe 14. With this construction, diameters of 10 mm and less can be achieved at the terminus portion 32.

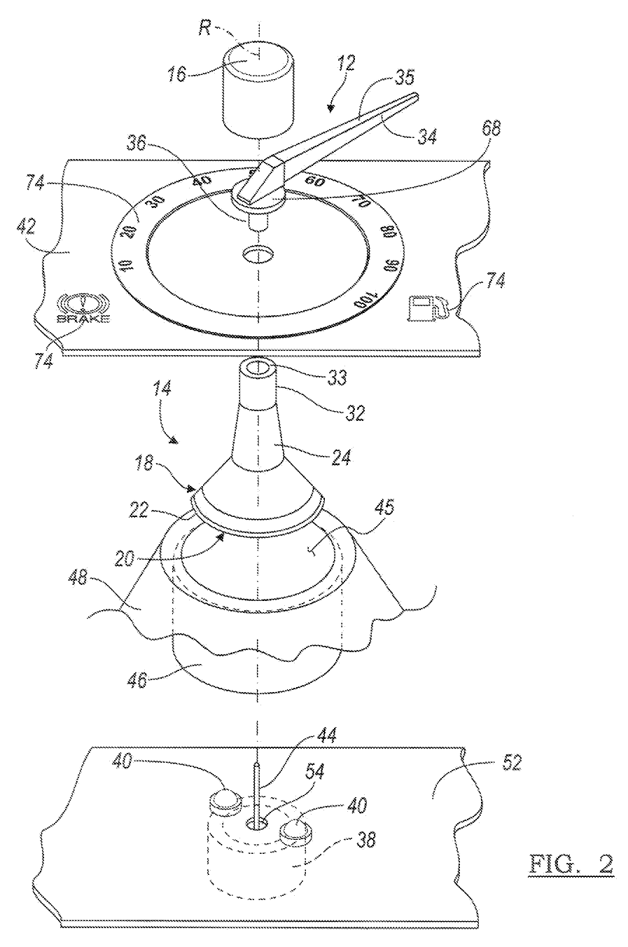

The terminus portion 32 is connected to the instrument pointer 12 and this can be achieved in any number of ways. As seen in FIG. 2, the instrument pointer 12 has a pointer blade 34, a hub 68 and a stem 36. The rotational axis R extends through the stem 36, and the blade 34 is configured to rotate about the rotational axis R with the stem 36 and hub 68. In this embodiment, the terminus portion 32 of the light pipe 14 is configured to define a bore 33 into which the stem 36 of the instrument pointer 12 is received in a press fit or other engagement that securely retains the instrument pointer 12 to the light pipe 14. Alternatively, the terminus portion 32 could be integrally formed with the instrument pointer 12 or it could be connected directly to the hub of the instrument pointer 12.

With reference to FIG. 2, more of the individual and related components of the instrument pointer assembly 10 may be seen, and such components may be provided with the instrument pointer assembly 10 to provide an instrument pointer assembly package.

In FIG. 2, it can be seen that the instrument pointer assembly 10 is configured for use with a motor 38, light sources 40, and an appliqué 42. The motor 38, which could be a stepper motor, has a shaft 44 extending therefrom along the rotational axis R. The shaft 44 extends into an opening 45 formed in what is commonly referred to as a chimney 46. As illustrated herein, the chimney 46 is formed as part of a back plate 48; however, it should be understood that the back plate 48 could also be formed separately from the chimney 46. The shaft 44 is configured to connect to the light pipe 14 and is operable to rotate the pointer blade portion 34 about the rotational axis R. The chimney 46 is configured to confine light emitted from light sources 40 within the chimney 46 and upward therefrom. This, in combination with the back plate 48, prevents light leakage to other areas of the appliqué 42. In other words, light is prevented from leaking to areas of the appliqué 42 that are not positioned adjacent to opening 45 of the chimney 46.

In the illustrated embodiment, a circuit board 52 is located above the motor 38 and the shaft 44 of the motor 38 extends through an opening 54 of the circuit board 52. It is contemplated, however, that the there could be other relationships between the motor 38 and the circuit board 52, without falling beyond the spirit and scope of the present invention. The circuit board 52 may further be assembled to an additional support plate (not shown), if needed. Located on the circuit board 52 are two light sources 40, which are LEDs 40 in this embodiment. Two LEDs 40 are shown on either side of the shaft 44; however, any number of LEDs 40 could be positioned radially around the shaft 44.

The appliqué 42 serves as a divider between the components that the viewer will see and the components that the viewer will not see. In other words, the appliqué 42 separates a viewable area 70 from a non-viewable area 72. The appliqué 42 may be glued, adhered, or otherwise attached to the back plate 48 and is generally opaque, but provided with indicia 74, such as letters, numbers, words, or icons, thereon. The indicia 74 are typically formed as translucent or transparent windows within the appliqué 42, such that light from various light sources located in the inner non-viewable area 72 shines through the indicia 74 to illuminate the indicia 74. The light sources that illuminate the indicia 74 could be the LEDs located outward of the chimney 46, and provided on the printed circuit board 52. Alternatively, they could be located within the chimney 46.

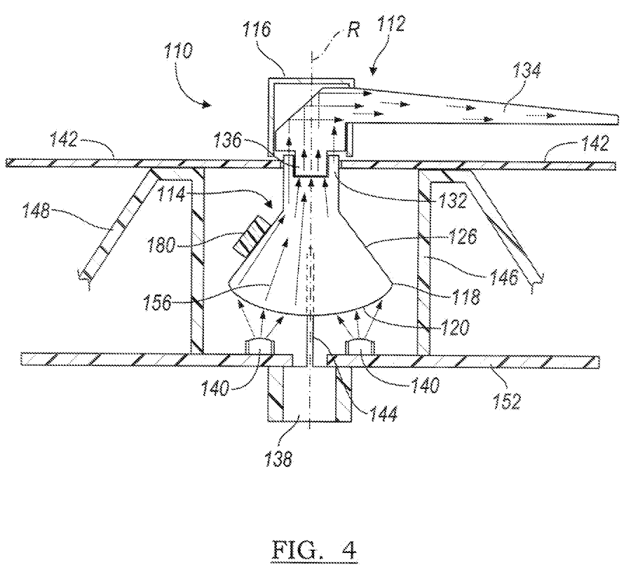

With reference to FIG. 3, a side cross-sectional view of the instrument pointer assembly 10 and associated components is illustrated. As will be appreciated from this figure, the instrument pointer assembly 10 is configured to collect light from light sources 40 and illuminate the instrument pointer blade portion 34. The LEDs 40 emit light rays 56, which travel through air and are incident on the outer surface of the focusing lens 22, where they enter the light pipe 14 through the light-collecting face 20. The focusing lens 22 may be a collimating lens, as shown in FIG. 3, that collimates the light rays 56.

After entering the light pipe 14 through the focusing lens 22, the light rays 56 continue to travel through the body of the light pipe 14, which is preferably formed of a transparent optical grade plastic. Alternatively, the light pipe 14 may be formed of any transparent or nearly transparent material. The base portion 18 of the light pipe 14 is designed such that the light rays 56 will strike the conical exterior surface 58 of the base portion 18 and will be totally internally reflected toward the center of the light pipe 14, in other words, toward the rotational axis R.

The base portion 18 of the light pipe 14 has a pocket 60 formed within it, one function of which to provide an inner surface 62 to reflect light rays 56 toward the terminus portion 32 of the light pipe 14. More particularly, the inner surface 62 is also formed conically so that, as the light rays 56 strike the inner surface 62, as shown in FIG. 3, at least a portion of the light rays 56 are totally internally reflected toward the terminus portion 32. The light rays 56 then travel through the intermediate portion 24, through the terminus portion 32, and into the stem 36 of the instrument pointer 12.

In this embodiment, the light rays 56 travel through the stem 36 of the instrument pointer 12, strike an angled top surface 64 (angled with respect to the axis R), where they are totally internally reflected into the blade 34 of the instrument pointer 12. The light rays 56 become visible to a viewer in the blade 34 of the instrument pointer 12 in that the viewable face 35 of the blade 34 allows incident light to be at least partially emitted therethrough. While a particular construction is provided for directing the light rays into the blade 34, it should be understood that the instrument pointer 12 could have other configurations that direct the light rays 56 to the blade 34, without falling beyond the spirit and scope of the present invention.

Since the terminus portion 32 connects to the stem 36 of the instrument pointer 12 at a point located above the appliqué 42 on the viewable side 70 of the assembly 10, the terminus portion 32 may be provided with an opaque exterior surface 66, via paint or other means, to help avoid light leakage around the instrument pointer 12. The opaque surface 66 could also or alternatively be metallic paint or metallization, which would, in addition to protecting against light leakage, help redirect light rays 56 that strike the outer surface of the upper portion 32. To further assist in this regard and to aesthetically enhance the assembly 10, a cap 16 is provided over the radially inner end of the blade 34, the hub 68 and stem 36, in a position along the rotational axis R. The cap 16 also prevents a viewer from being able to see the LEDs 40 and other contents located in the chimney 46. To these ends, the cap 16 is preferably comprised of opaque material.

With reference to FIG. 4, another embodiment of an instrument pointer assembly 110 embodying the principles of the present invention is illustrated therein. The instrument pointer assembly 110 is similar to the previously discussed embodiment and includes a light pipe 114 and an instrument pointer 112, which has a blade 134 and a stem 136 and may also include a cap 116. Like the previous instrument pointer assembly 10, the instrument pointer assembly 110 of FIG. 4 is also configured to rotate about a rotational axis R.

The light pipe 114 of the present embodiment is simpler in construction than the light pipe 14 of FIGS. 1-3. This light pipe 114 includes a conical base portion 118, with a side 126 that tapers inward toward the axis R in the direction toward a terminus portion 132. As such, base portion 118 has a larger diameter than the terminus portion 132. Notably, an intermediate portion is not located between the base portion 118 and the terminus portion 132. The base portion 118 also includes a light-collecting face 120 with a hemispherical shape, although it may have other shapes without falling beyond the spirit and scope of the present invention, such as a flat, circular shape. The light-collecting face 120 may or may not have surface optics, such as focusing lenses or collimating features (none of which are shown in of FIG. 4).

The terminus portion 132 is connected to the stem 136 of the instrument pointer 112 as described in conjunction with the prior embodiment. Similarly, the terminus portion 132 could alternatively be integrally formed with the instrument pointer 112, or it could be connected via a hub or other structure that further connects the upper portion 132 to the instrument pointer 112.

Like the previous instrument pointer assembly 10, the instrument pointer assembly 110 of FIG. 4 may be similarly constructed and used with a motor 138, light sources 140, a circuit board 152, a back plate 148, and an appliqué 142. The motor 138 has a shaft 144 extending therefrom along the rotational axis R, and the shaft 144 is configured to connect to the light pipe 114 so as to rotate the pointer blade 134 of the instrument pointer 112 about the rotational axis R.

The LEDs 140 are similarly disposed on the circuit board 152 and generate light rays 156 that travel through air and are incident on the light-collecting face 120 of the light pipe 114. The spherical surface of the light-collecting face 120 is configured to direct the light rays 156 inward toward the rotational axis R and the terminus portion 132. As such, the light rays 156 travel at an acute angle with respect to a normal plane N, wherein the normal plane N is coplanar with the surface of the appliqué 142. The light rays 156 continue through the light pipe 114 and into the stem 136 of the instrument pointer 112. Like the instrument pointer 12 of FIGS. 1-3, the instrument pointer 112 of this embodiment has an angled surface 164 that reflects the light rays 156 into the blade 134 by principles of total internal reflection.

Due to the length and weight of the blade 134 of the instrument pointer 112, the instrument pointer assembly 110 may become imbalanced under the influence of gravity, which could cause the blade 134 to interfere with other components, such as the appliqué 142, during rotation. Therefore, a weight 180 may be provided and attached to the light pipe 114, or elsewhere. The weight 180 is located so as to balance the mass of the blade 134 and will therefore typically be provided opposite of the blade 134. While not shown in the prior embodiment, the weight could be incorporated therein and used therewith.

As a person skilled in the art will readily appreciate, the above description is meant as an illustration of implementation of the principles of this invention. This description is not intended to limit the scope or application of this invention in that the invention is susceptible to modification, variation and change, without departing from the spirit of this invention, as defined in the following claims.

We claim:

1. An instrument pointer assembly for illuminating an instrument pointer, the assembly comprising:
an instrument pointer having a blade and a stem, the stem defining a rotational axis extending therethrough, the blade portion coupled to the stem to rotate about the rotational axis;
a light pipe, the light pipe being a body of revolution that is: symmetric about the rotational axis, the light pipe comprising:
a terminus portion and a base portion, the terminus portion being connected to the stem of the instrument pointer and being rotatable about the rotational axis, the terminus portion defining a first effective diameter, the base portion being located along the rotational axis at a position that is longitudinally farther away from the stem than the terminus portion, the base portion having a generally conical shape and defining a second effective diameter that is greater than the first effective diameter; and
a light-collecting face provided on the base portion, the light-collecting face being configured to collect light from a light source, whereby the light pipe is configured to transmit at least a portion of the light to the blade of the instrument pointer.

2. The instrument pointer assembly of claim 1, wherein the rotational axis extends centrally through the base portion.

3. The instrument pointer assembly of claim 1, wherein the light collecting face of the light pipe includes a focusing lens, and the light collecting face is an axially oriented face.

4. The instrument pointer assembly of claim 1, wherein the base portion includes a tapering side surface and, proceeding from the light collecting face toward the terminus portion, the tapering side surface tapers inwardly toward the rotational axis.

5. The instrument pointer assembly of claim 1, further comprising an intermediate portion located between the terminus portion and the base portion, the intermediate portion having sides tapering inwardly from the base portion toward the terminus portion.

6. The instrument pointer assembly of claim 1, further comprising an intermediate portion located between the terminus portion and the base portion, the intermediate portion defining a conical shape.

7. The instrument pointer assembly of claim 1, wherein the terminus portion has an opaque exterior surface.

8. The instrument pointer assembly of claim 1, further comprising a counterweight disposed on the assembly to balance the mass of the instrument pointer.

9. The instrument pointer assembly of claim 1, further comprising a cap, the cap being disposed on the instrument pointer at a location along the rotational axis.

10. An instrument pointer assembly package for illuminating an instrument pointer, the assembly package comprising:
a motor having a rotatable shaft extending therefrom and defining a rotational axis;
an instrument pointer having a blade and a stem, the stem being coupled to the shaft and being rotatable about the rotational axis;
a plurality of light sources positioned generally about the shaft; and
a light pipe connected to the shaft, the light pipe comprising:
a terminus portion located along the rotational axis and being connected to the stem, the terminus portion defining a first effective diameter;
a base portion located along the rotational axis at a position longitudinally farther away from the instrument pointer than the terminus portion, the base portion defining a second effective diameter that is larger than the first effective diameter and including a radial surface that tapers generally toward the rotational axis, the base portion further defining a light collecting face that is axially oriented toward the light sources; and
whereby light from the light sources is received by the light collecting face of the base portion and transmitted through the light pipe to the instrument pointer.

11. The instrument pointer assembly package of claim 10, wherein the base portion is circular in transverse cross sectional shape.

12. The instrument pointer assembly package of claim 10, wherein the base portion is conical in shape.

13. The instrument pointer assembly package of claim 10, wherein the base portion includes portions defining a pocket centrally within the light collecting face.

14. The instrument pointer assembly package of claim 10, wherein the plurality of light sources includes at least one light-emitting diode.

15. The instrument pointer assembly package of claim 10, further comprising an appliqué, the appliqué being positioned between the blade of the instrument pointer and the light collecting face of the light pipe.

16. The instrument pointer assembly package of claim 15, wherein the appliqué includes indicia formed thereon, the indicia including at least one of letters, numerals, and icons.
